(19) United States
(12) Patent Application Publication
(10) Pub. No.: US 2026/0073246 A1
(43) Pub. Date: Mar. 12, 2026

(54) GENERATIVE AI-DRIVEN SYSTEM FOR AGILE EDUCATIONAL CONTENT CREATION AND MANAGEMENT IN RAPIDLY CHANGING AND HIGH-STAKES FIELDS

(71) Applicant: ZYGLIO INC, Reston, VA (US)

(72) Inventor: Jonathan MERRIL, Reston, VA (US)

(73) Assignee: ZYGLIO INC, Reston, VA (US)

(21) Appl. No.: 18/883,494

(22) Filed: Sep. 12, 2024

(51) Int. Cl. G06N 5/022

(52) U.S. Cl. CPC G06N 5/022

(57) ABSTRACT

A method for creating and managing knowledge-based content using generative artificial intelligence (AI) includes: storing one or more profiles including a user identifier and a user knowledge-based history for one or more knowledge-based topics; storing one or more knowledge maps for an knowledge-based topic including at least links between concepts of an knowledge-based topic and knowledge-based material items; receiving a content request from a computing device, the content request including a user identifier and an knowledge-based topic; identifying a user profile of the one or more user profiles including the user identifier of the content request; identifying a knowledge map of the one or more knowledge maps matching the knowledge-based topic of the content request; identifying one or more user knowledge gaps; generating one or more new knowledge-based material items for addressing each of the identified one or more user knowledge gaps using a generative machine learning model.

### FIELD

The present disclosure relates to systems and methods for creating, managing, and monetizing a narrative-driven knowledge platform, specifically the integration of knowledge mapping to identify user knowledge gaps for the creation of user-specific content, enhanced multimedia workflows, generative custom simulations, and/or monetization strategies through advertising and sponsorship networks.

### BACKGROUND

Many industries regularly see great advancements in technology, updates to best practices, changes in compliance requirements, and other shifts that are often valuable for professionals to keep up to date on. In fact, some industries actually place requirements on professionals to receive continuing education in order to maintain licenses and certifications, such as the medical and legal industries. As a result, there are many platforms that have been created that are designed to provide professionals with knowledge-based materials for learning related to their industry. These platforms typically provide libraries of presentations, articles, and papers that a professional can view in order to expand their knowledge.

However, these platforms are often static and can quickly be outdated in rapidly changing fields. In addition, existing platforms typically require the user to navigate and find content for consumption themselves, placing the burden on the user to know the information they are trying to obtain and locate it in an increasingly expanding database. This can become exceedingly difficult as technology advances and knowledge-based requirements change, leading to a professional missing out on required coursework or emerging new technologies and practices in their industry. Further, current platforms often fail to fully engage users or adapt to their evolving needs and lack comprehensive feedback systems, interactive simulations, and effective monetization strategies. There is a growing demand for systems and methods that not only deliver knowledge content but also encourage user participation, provide immersive experiences, and offer incentives for completion.

Thus, there is a need for a new technological solution that can provide for a system that can create up-to-date knowledge-based materials and content that can be specifically tailored to the learning needs of a user.

### SUMMARY

Embodiments of the present invention provide a holistic platform that integrates multiple advanced features to enhance the learning experience, drive user engagement, and create new revenue streams. The present disclosure provides a description of systems and methods for creating and managing knowledge-based content using generative artificial intelligence (AI). Knowledge-based materials items are received by a processing server that is specially configured to generate a knowledge map based thereon that includes links between concepts and the knowledge-based material items. The processing server can identify user knowledge gaps, such as for a specific user based on that user's current knowledge and education in comparison to the knowledge map. The processing server can generate a curriculum plan designed to fill in the user knowledge gaps and then use generative AI to create new knowledge-based material items to facilitate the curriculum plan. The new knowledge-based materials can then be delivered to the specific user for consumption in a manner that is specifically tailored to their needs and kept up-to-date based on all available data. In some cases, the new knowledge-based materials can be indexed and compiled into multiple briefings for user convenience. Feedback can be captured from the users for further development of future knowledge-based materials.

A method for creating and managing knowledge-based content using generative artificial intelligence (AI) includes: storing, in a database of a processing server, one or more profiles, each of the one or more profiles including a user identifier and a user knowledge-based history for one or more knowledge-based topics; storing, in the database of the processing server, one or more knowledge maps, each of the one or more knowledge maps being for an knowledge-based topic, each of the one or more knowledge maps including at least links between concepts of an knowledge-based topic and knowledge-based material items; receiving, by the receiver of the processing server, a content request from a computing device, the content request including a user identifier and an knowledge-based topic; identifying, by the processor of the processing server, a user profile of the one or more user profiles including the user identifier of the content request; identifying, by the processor of the processing server, a knowledge map of the one or more knowledge maps matching the knowledge-based topic of the content request; identifying, by the processor of the processing server, one or more user knowledge gaps, wherein identifying the one or more user knowledge gaps includes: comparing the identified user profile to the identified knowledge map; generating, by the processor of the processing server, one or more new knowledge-based material items for addressing each of the identified one or more user knowledge gaps using a generative machine learning model; and transmitting, by a transmitter of the processing server, the generated one or more new knowledge-based materials to the computing device.

A system for creating and managing knowledge-based content using generative artificial intelligence (AI) includes a processor and a non-transitory memory coupled to the processor and storing instructions that, when executed by the processor, cause the system to perform operations, comprising: storing, in a database, one or more profiles, each of the one or more profiles including a user identifier and a user knowledge-based history for one or more knowledge-based topics; storing, in the database, one or more knowledge maps, each of the one or more knowledge maps being for an knowledge-based topic, each of the one or more knowledge maps including at least links between concepts of an knowledge-based topic and knowledge-based material items; receiving a content request from a computing device, the content request including a user identifier and an knowledge-based topic; identifying a user profile of the one or more user profiles including the user identifier of the content request; identifying a knowledge map of the one or more knowledge maps matching the knowledge-based topic of the content request; identifying one or more user knowledge gaps, wherein identifying the one or more user knowledge gaps includes: comparing the identified user profile to the identified knowledge map; generating one or more new knowledge-based material items for addressing each of the identified one or more user knowledge gaps using a generative machine learning model; and transmitting the generated one or more new knowledge-based materials to the computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for creating and managing knowledge-based content in accordance with exemplary embodiments;

FIG. 2 is a block diagram illustrating the processing server of the system of FIG. 1 for creating and managing knowledge-based content in accordance with exemplary embodiments;

FIGS. 3A and 3B are a flow diagram illustrating a process for the creation and delivery of knowledge-based content in the system of FIG. 1 in accordance with exemplary embodiments;

FIG. 4 is a flow chart illustrating an exemplary method for creating and managing knowledge-based content in accordance with exemplary embodiments; and

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Agile Knowledge-based Content Creation and Management

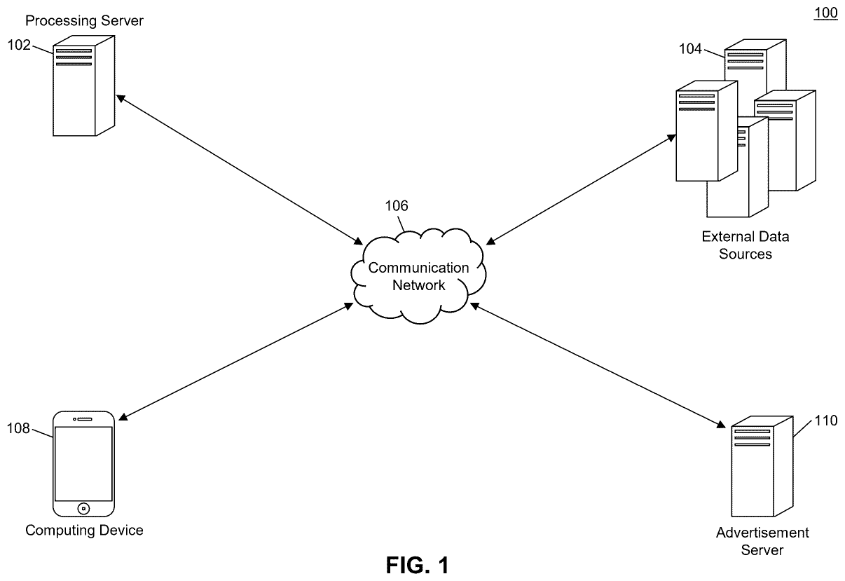

FIG. 1 illustrates a system 100 for agile knowledge-based content creation and management that utilizes knowledge mapping and generative artificial intelligence (AI). The system 100 provides a modular framework that allows learners to create, upload, and share content, such as video messages, articles, and interactive media that is reviewed through a multi-tiered moderation process and seamlessly integrated into the existing narrative-driven content The system 100 can include a processing server 102. The processing server 102, discussed in more detail below, can be a specially configured device that is configured to perform functions discussed herein related to the creation and management of knowledge-based content items. Knowledge-based content items can be items of any suitable data type that can be used in the creation of additional knowledge-based content and the conveying of information to a professional for the purposes of education. Data types for knowledge-based content items can include, for example, text, audio, video, and interactive media. Knowledge-based content items can include books, articles, presentations, slide decks, speeches, white papers, technical papers, manuals, podcasts, films, etc. In some cases, knowledge-based content items can vary depending on the industry to which the items are related.

The processing server 102 can be configured to obtain as many knowledge-based content items as desired for any given industry. The processing server 102 can obtain the knowledge-based content items using any suitable method. In an exemplary embodiment, the processing server 102 can receive knowledge-based content items from a plurality of different external data sources 104. The external data sources 104 can include any device, system, entity, etc. that produces, stores, or otherwise has available knowledge-based content items for a given industry. Examples of external data sources 104 can include research institutions, cataloguing services, book publishers, colleges and universities, laboratories, standard setting entities, regulatory agencies, etc., as well as illustrative segments, commentary or fully formed educational content from a variety of sources (e.g., present or past employees, customers) consisting of text, audio and/or video content that is crowd-sourced. The processing server 102 can receive knowledge-based content items from external data sources 104 via a communication network 106, such as a local area network or the Internet, and/or can receive knowledge-based content items via one or more physical media, such as a universal serial bus (USB) flash drive that contains digitized knowledge-based content items, books that can be scanned or digitized by the processing server 102 using suitable methods, etc.

In embodiments, the network 106 is the Internet, representing a worldwide collection of networks and gateways to support communications between devices connected to the Internet. The network 106 may include, for example, wired, wireless or fiber optic connections. In other embodiments, the network 106 may be implemented as an intranet, a local area network (LAN), or a wide area network (WAN). In general, the network 106 can be any combination of connections and protocols that will support communications between the processing server 102, the external data sources 104, and the computing device 108. In embodiments, the network 104 may distributed network such as a peer-to-peer (P2P) network.

The system 100 can also include a computing device 108. The computing device 108 can be a device utilized by a user to interact with the processing server 102, the external data sources 104, and/or the advertisement server 110 for accessing services provided thereby. The computing device 108 can communicate with the processing server 102, the external data sources 104, and/or the advertisement server 110 via the communication network 106 and can utilize a webpage, application program, application programming interface (API), or other suitable method for communicating with the processing server 102, the external data sources 104, and/or the advertisement server 110. A user interface displayed by the computing device 108 to the user can enable the user to request knowledge-based content items from the processing server 102.

The system 100 can also include an advertisement server 110. The advertisement server 110 can be a device utilized by a user to interact with the processing server 102, the external data sources 104, and/or the computing device 108 for providing services provided thereto. The advertisement server 110 can communicate with the processing server 102, the external data sources 104, and/or the computing device 108 via the communication network 106. The advertisement server 110 can generate, store, manage, and transmit advertisements for insertion into the knowledge-based content items generated by the processing server 102 and viewed by the computing device 108. The advertisements can include, but are not limited to, banner ads, video ads, and/or sponsored content segments. In embodiments, the advertisement server 110 can function as part of the same entity as the processing server 102 and/or the advertisement server 110 can function independently of the processing server 102. For example, the advertisement server 110 can function as an advertisement database for the processing server 102 for advertisements generated and/or received by the processing server 102. Alternatively, and/or together with an internal advertisement database, the advertisement server 110 can be operated by a third-party advertisement entity that provides advertisements to the processing server 102. In embodiments, the processing server 102 generates knowledge-based content items for a specific topic and the processing server 102 then requests relevant advertisements for insertion and/or display with the knowledge-based content items.

In an exemplary embodiment, the computing device 108 can electronically transmit a request for knowledge-based content items to the processing server 102 via the communication network 106 using any suitable communication method. The request for knowledge-based content items can include a user profile or a user identification for a user of the computing device 108 and/or other data for use by the processing server 102 in identifying a user profile for the user of the computing device 108 (e.g., as can be stored in the profile database 210 of the processing server 102). The request can include information identifying the user, an industry and/or specific knowledge-based topic, and any additional user data that can be used by the processing server 102 in identifying gaps in knowledge, sentiment, relevancy or other metadata that is pre-existing data or derived by interaction with user and/or areas for which knowledge-based content items should be created, as discussed in more detail below. In an example, a user profile for a user in the legal profession can include user data such as: a number of years of experience, a list of completed courses, a list of active licenses and memberships for the user, and/or preferred practice areas, etc.

The processing server 102 can receive knowledge-based content items and other materials for an industry or a specific knowledge-based topic from the plurality of external data sources 104 and internally stored knowledge-based content items, including knowledge-based content items created for use by other users in prior executions of the processes discussed herein. The industry or specific knowledge-based topic can be industry level, enterprise level, job-specific, and/or employee-specific. For example, the industry or specific knowledge-based topic could be recent case law updates in the legal field, which would encompass the entire legal industry. As another example, the industry or specific knowledge-based topic could be recent updates in intellectual property law, which would encompass a job-specific topic within the legal industry. An employee-specific example of an industry or specific knowledge-based topic may be recent updates in intellectual property law not known by a particular employee based on the particular employee's knowledge-based history, e.g., as defined in a user profile associated with that particular employee. An enterprise level example of an industry or specific knowledge-based topic may be recent updates for a specific company, e.g., new security protocols, operating procedures, etc. In some embodiments, the processing server 102 can then use metadata extraction to extract metadata from the ingested knowledge-based content items and other materials, which can include various data values based on the data type and content type of the knowledge-based content item or other material, such as an author, speaker, title, creation date, publishing date, abstract, applicable geography, applicable jurisdiction, applicable regulations, etc. The processing server 102 can store the ingested knowledge-based content items and other materials and the metadata in the content database 206, e.g., as the content items 208. The processing server 102 can retrieve the knowledge-based content items and other materials at the request of an entity in control of the processing server 102. For example, the processing server 102 may be operated by a law firm that has one or more legal practice areas, and an administrator of the law firm may define one or more knowledge-based topics based on those legal practice areas for which the processing server 102 should retrieve knowledge-based content items and other materials. In embodiments, the processing server 102 can receive knowledge-based content items and other materials for an industry or a specific knowledge-based topic from users, e.g., computing devices 108. As an example, the processing server 102 may retrieve knowledge-based content items from an employer, which can include, but is not limited to, employer manuals, employer standard operating procedures. As another example, an employer may define consequences for certain knowledge gaps of an employee and/or the employer may define benefits of filling certain knowledge gaps, e.g., skills acquisition, by an employee, which can be used by the processing server 102 to generate simulations, which are discussed in more detail below. In embodiments, the processing server 102 may retrieve the knowledge-based content items and other materials in response to the request for knowledge-based content items received from the computing device 108. In another embodiment, the system 100 (e.g., the processing server 102) using generative AI and behavioral/knowledge assessment can be used to create a pipeline that human resources in a company can use to screen for relevant employees through a screening process to determine the degree of challenge associated with education and behavior change of each individual as well as personalizing and cultivating interest and expertise in the individual's particular areas of knowledge and/or skills. Yet another embodiment could assist pharmaceutical companies in identifying key opinion leaders (KOLs) and cultivating healthcare providers who may be open to a new therapeutic product.

The system can function within the context of an organization's CRM/HR system (customer relationship management/human resource) product such as PeopleSoft®, SalesForce®, and HubSpot®, etc. Alternatively, the system can be provided as a direct-to-consumer application that affords individuals to self-direct their work with the platform, use in pre-employment, and be used to educate individuals in skills that are applicable to a wide range of potential employment by a variety of companies.

In one embodiment, the system 100 (e.g., the processing server 102) stores (e.g., in the user profile 212) developmental benchmarks that can be compared against real-time user data, enabling the system 100 to adjust learning materials and behavior modification techniques dynamically. For example, the processing server 102 can further include an initial screening and behavioral assessment module (e.g., as part of the analysis module 220), a customized developmental pathways and behavioral intervention engine (e.g., as part of the generation module 218), a feedback and progress monitoring mechanism (e.g., a part of the feedback module 222), and a long-term skill development and behavioral reinforcement module (e.g., as part of the feedback module 222).

The initial screening and behavioral assessment module utilizes a combination of psychometric assessments, skill-based evaluations, and observational data collection. The initial screening and behavioral assessment module can be configured to evaluate user behavior and current competencies using predefined criteria. In some embodiments, the system 100 (e.g., the processing server 102) may include AI-powered analytics that monitor user interactions and extract behavioral patterns, identifying strengths, weaknesses, and skill gaps in real-time. These analytics may allow for continuous and adaptive screening, ensuring the data remains current and reflective of the user's developmental stage.

Upon completion of the initial screening, the system 100 (e.g., the processing server 102) can activate the customized developmental pathways and behavioral intervention engine tailored to the individual's needs. Customized developmental pathway generation is driven by machine learning algorithms that assess the user's baseline and create specific learning objectives aimed at enhancing the user's skill set. The system 100 (e.g., the processing server 102) can provide personalized learning materials that adjust dynamically based on the user's progress. For behavior modification, the system 100 (e.g., the processing server 102) can incorporate reinforcement strategies, such as a token economy or gamification techniques, which can be triggered by predefined behavior patterns identified during the assessment.

The system 100 (e.g., the processing server 102) can be designed to influence behavior positively through motivational incentives and structured feedback loops. The feedback and progress monitoring mechanism (e.g., the feedback module 222) can be configured to provide real-time data on the user's progress. The feedback and progress monitoring mechanism (e.g., the feedback module 222) can leverage performance analytics, progress-tracking dashboards, and AI-driven insights to continuously inform the user of incremental improvements or areas requiring additional focus. In some embodiments, the system 100 (e.g., the processing server 102) may utilize adaptive feedback models that respond to user input with increasing specificity. For behavioral monitoring, the feedback and progress monitoring mechanism (e.g., the feedback module 222) may trigger alerts when predefined behavioral milestones are reached or if deviations from expected development trajectories are detected.

The long-term skill development and behavioral reinforcement module reinforces learned skills and behaviors through iterative testing and feedback mechanisms. Adaptive testing features are incorporated, which adjust the difficulty of assessments as the user progresses through different stages of learning. Additionally, the system 100 (e.g., the processing server 102) can be designed to integrate soft skills training via scenario-based simulations or virtual environments that replicate real-world conditions. Behavioral coaching functions, including peer mentoring and AI-based recommendations, are employed to ensure sustainable behavioral changes and ongoing skill development. The system 100 (e.g., the processing server 102) can support a continuous improvement cycle, wherein the behavioral and skill development modules operate iteratively to promote long-term growth.

In some embodiments, the processing server 102 can utilize both parallel and sequential processes for data retrieval for retrieving knowledge-based content items and other materials for use in the methods discussed herein. Parallel retrieval can include the simultaneous querying of multiple data sources to gather a comprehensive data set, while sequential retrieval can include the execution of iterative queries based on initial content that is refined and enhanced through subsequent queries and can dynamically adjust to fill knowledge gaps and correct inaccuracies.

Once existing knowledge-based content items and materials have been obtained and processed by the processing server 102, the processing server 102 can generate a knowledge map for the identified industry or specific knowledge-based topic for the user. The knowledge map can include a plurality of links between concepts for the identified industry or specific knowledge-based topic and the processed knowledge-based content items and other materials. The processing server 102 can utilize a mapping database that includes existing information regarding linkages between concepts and content items, extracted metadata for the processed knowledge-based content items, concept data for the identified industry and specific knowledge-based topic, and other suitable data in order to generate the knowledge map. In some cases, one or more machine learning models or algorithms can be used. In such cases, the processing server 102 can create a machine learning model for use in generating knowledge maps, which can be trained using knowledge maps generated by the processing server 102 and feedback received regarding knowledge mapping, user knowledge gaps, and created knowledge-based content items, as discussed in more detail below.

Once the knowledge map has been created, the processing server 102 stores the knowledge map, e.g., in the content database 206 or the memory 214. The processing server 102 can analyze the knowledge map to identify one or more user knowledge gaps in education for the user based on a comparison of the knowledge map and the user profile for the user. The processing server 102 can generate, update, and maintain a knowledge map for the identified industry or specific topic, where user knowledge gaps can be identified using the information in the user profile. In some embodiments, the processing server 102 can utilize natural language processing and machine learning models to analyze the knowledge map to identify user knowledge gaps based on the user profile. In such embodiments, the processing server 102 can create a machine learning model for use in identifying the user knowledge gaps, which can be trained using data regarding prior user knowledge gaps identified by the processing server 102 and feedback received regarding knowledge mapping, user knowledge gaps, and created knowledge-based content items, as discussed in more detail below. In some embodiments, the generated knowledge map can be specific to the user and generated via use of the user profile, where the knowledge map can include gaps where concepts are not sufficiently indicated in the user profile.

In an example, a user of the computing device 108 can be a lawyer with ten years of experience that has prior coursework in several different areas of law, is interested in obtaining knowledge-based content items suitable for satisfying continuing legal education requirements in specific jurisdictions (e.g., Virginia and Maryland), and has a specific practice area interest of intellectual property with an emphasis on patents. The processing server 102 can retrieve and/or generate a knowledge map for intellectual property law and, using the user's profile regarding past coursework and area of interest, identify user knowledge gaps regarding recent developments in patent law including new modifications to federal rules, changes to United States Patent & Trademark Office requirements for patents, and recent case law related to patent infringement. As another example, a law firm may have an associate attorney with five-years of experience in a legal practice area and a partner attorney with twenty-years of experience in the same legal practice area, and the processing server 102 can generate a knowledge map based on the partner attorney, e.g., using a user profile associated with the partner attorney, using the a user profile associated with the associate attorney, identify user knowledge gaps between the associate attorney and the partner attorney.

Once user knowledge gaps have been identified, the processing server can generate a curriculum plan for the user based on the gap analysis and the user profile. In the above example, the curriculum plan can include a plan for a suitable number of courses/knowledge-based materials that satisfy the continuing legal education requirements needed for the lawyer in both Virginia and Maryland with courses that cover the identified user knowledge gaps. The processing server 102 can then utilize generative AI to create new knowledge-based content items that will satisfy the generated curriculum plan for the user. In the above example, the knowledge-based content items will include courses (e.g., including slide decks, accompany audio, and other materials) of sufficient length that satisfy the requirements of Virginia and Maryland. The knowledge-based content items can include simulations of how particular knowledge gaps can affect a user's job performance. These simulations can include characters, dialogues, and interactive elements that reflect real-world job environments that users can interact with such as by making decisions that influence the outcome, thus reinforcing the learning objectives of the knowledge-based content items. Further, the knowledge-based content items can include narrative-based simulations based on a user's job. For example, the knowledge-based content items can include personalized video and audio simulations, including dialogues and characters, of situations likely to be encountered by the user in the performance of the job. The narrative-based simulations can include decision points that require user input and/or selection to proceed. For example, a narrative-based simulation may present a user with two or more options for responding to a certain individual in the narrative-based simulation and the user's selection will dictate how the narrative-based simulation proceeds. The generative AI can create the knowledge-based content items using the ingested knowledge-based content items and other materials and can work iteratively to refine previously created knowledge-based content items based on more recently ingested knowledge-based content items and materials and feedback captured using the methods discussed herein.

In some embodiments, the processing server 102 can ingest additional knowledge-based content items and other materials not included in the generation of the knowledge map using retrieval-augmented generation (RAG) and/or corrective RAG (CRAG). RAG can synthesize the additional knowledge-based content items and other materials to ensure comprehensive coverage of the identified industry or specific knowledge-based topic, while CRAG can further employ a corrective mechanism to RAG that iteratively verifies and refines the generated content using secondary retrievals for increased accuracy and reliability.

The processing server 102 can then provide the created knowledge-based content items to the computing device 108 for use by the user in filling the identified user knowledge gaps in their education. In some cases, the created knowledge-based content items can be electronically transmitted to the computing device 108 for storage and access thereon by the user. In other cases, the computing device 108 can remotely access the created knowledge-based content items from the processing server 102 via the communication network 106 using any suitable communication method. In the above example, the lawyer can use an application program on the computing device 108 to view each created course to fulfill their continuing legal education requirements in Virginia and Maryland to maintain their license while learning up-to-date information in their interested practice area.

In some embodiments, the processing server 102 can insert advertisements into the created knowledge-based content items being transmitted to and/or accessed by the computing device 108. For example, the processing server 102 may insert banner ads, video ads, and/or sponsored content items into the created knowledge-based content items. In embodiments, the advertisements inserted into the created knowledge-based content items are relevant to the created knowledge-based content items. For example, if the created knowledge-based content item is a continuing legal education seminar, the processing server 102 can insert a banner advertisement for a legal services provider. The processing server 102 can insert the advertisement by generating an advertisement request that includes a topic and/or subject of the created knowledge-based content item and transmit the advertisement request to the advertisement server 110. The advertisement server 110 can generate and/or identify a relevant advertisement based on the advertisement request and transmit the identified advertisement to the processing server 102. In embodiments, the processing server 102 and/or the advertisement server 110 can store in an advertisement database advertisements that are tagged with certain keywords or contain metadata that enable to the processing server 102 and/or the advertisement server 110 to identify relevant advertisements for insertion into the created knowledge-based content items based on a topic and/or subject of the created knowledge-based content items.

In some embodiments, the processing server 102 can further process the created knowledge-based content items prior to delivery to a computing device 108. For instance, the processing server 102 can index the created knowledge-based content items according to a taxonomy of the generated knowledge map, where the index can enable a user to quickly search, retrieve, and cross-reference the created knowledge-based content items as well as other knowledge-based content items and materials ingested by the processing server 102. In some embodiments, the processing server 102 can assign classifications to created knowledge-based content items as well as the knowledge-based content items and other materials ingested by the processing server 102, which can be aligned with the taxonomy of the generated knowledge map and help facilitate searching and access by users. In some such embodiments, the processing server 102 can break down larger knowledge-based content items and other materials that are ingested into smaller subparts for better classification, easier processing via the machine learning models and generative AI and reduced computational costs.

In an exemplary embodiment, the processing server 102 can continuously update and improve its machine learning models, generative AI, knowledge maps, and repository of knowledge-based content items and other materials. The processing server 102 can train its machine learning models and generative AI using new and updated knowledge maps, user knowledge gap analysis, created knowledge-based content items, and newly received and ingested knowledge-based content items and other materials. The processing server 102 can update its knowledge maps to include new concepts, modify existing concepts, remove, add, or modify links between concepts and knowledge-based content items, modify the taxonomy using new data, etc.

In an exemplary embodiment, the processing server 102 can utilize feedback from users of computing devices 108 in order to update and improve the data and processes used by the processing server 102 as discussed herein. Feedback can be provided by computing devices 108 via the communication network 106 using any suitable communication method and be related to any and all aspects of the knowledge mapping, gap analysis, content creation, content indexing, content classification, and content delivery processes. For instance, users can provide feedback for knowledge mapping regarding the taxonomy of a knowledge map, the concepts included on the knowledge map, existing links between concepts and knowledge-based content items, suggested new links between concepts and knowledge-based content items. In another example, users can provide feedback regarding the accuracy of created knowledge-based content items, effectiveness of the type of content, knowledge-based effectiveness of the content, etc. In embodiments, stakeholders in a user's performance can provide feedback that can be used by the processing server 102 to update and improve the data and processes used by the processing server 102 as discussed herein. For example, such stakeholders of the user can include, but are not limited to, employees, customers, peers, and supervisors.

In some embodiments, the processing server 102 can maintain user profiles for each user that can utilize feedback provided by the specific user when creating and delivering content for that specific user. For instance, feedback from a first user can indicate that the user prefers interactive content with audio recordings that use a voice with a specific tone and cadence, while feedback from a second user can indicate that the user prefers slide decks with concise language and no accompanying audio. The processing server 102 can, when creating knowledge-based content items, create content that is specifically tailored to the individual user preferences for that user based on their past feedback. The processing server 102 can also utilize feedback from other users with the same or similar preferences in creating or selecting knowledge-based content items for a user. In some instances, the processing server 102 can transmit a list of questions to a computing device 108 when a user first interacts with the processing server 102 for initial development of the user profile, such as to request user preferences regarding content types, learning objectives, etc.

The processing server 102 can utilize feedback, user profiles, and adaptive learning to create and maintain a personalized learning path for a user in filling their gaps in knowledge. In such an embodiment, the processing server 102 can adapt the personalized learning path as the user consumes the knowledge-based content items for greater effectiveness. In an example, knowledge-based content items created by the processing server 102 can include quizzes for the user to take once a presentation has been completed to assess the user's learning of the subject matter covered by the presentation. The results of each quiz can be used to tailor the knowledge-based content items being created for further learning, such as by emphasizing content types deemed to be more effective or using use cases or examples deemed to be more effective based on the user's quiz results. For example, a specific user can show greater success in learning concepts with examples written in the style of a newspaper article as compared to examples written in the style of an anecdote told by a colleague, where future examples in created knowledge-based content items can adopt that particular style even in cases where such a preference can be previously unknown by the user. As another example, a user's employer may provide feedback on the user's performance and/or interaction with the knowledge-based content items. The results of the employer's feedback can be used to tailor the knowledge-based content items being created for further learning, such as by emphasizing content types deemed to be more pertinent to the user's job. In another embodiment, the system 100 (e.g., the processing server 102) can use the tools and techniques described in this application to allow the end-user to explore alternative career paths and/or positions within a given organization.

In embodiments, the processing server 102 can generate reports based on a user's interaction with the created knowledge-based content items. For example, but not limited to, the processing server 102 can generate one or more of: a completion certificate indicating that a user has completed a completed a created knowledge-based content item, a progress report indicating a user's interaction with and/or level of completion of one or more created knowledge-based content items; a progress report indicating a user's completion of one or more created knowledge-based content items included in an employer checklist of created knowledge-based content items, a score report indicating a user's score one or more assessments included and/or associated with a created knowledge-based content item, a user history report summarizing a user's interaction with one or more created knowledge-based content items over a defined period of time, etc.

In some embodiments, the processing server 102 can also update user profiles over time. In such an embodiment, as a knowledge map is updated, the processing server 102 can identify user profiles previously associated with the knowledge map to identify new gaps in learning for that user. For instance, in the above example, new case law regarding patent infringement could occur and the processing server 102 can proactively identify a user knowledge gap in the user profile for that concept. The processing server 102 can electronically transmit a notification message to the computing device 108 of the lawyer to notify the lawyer of the user knowledge gap and invite the lawyer to request a new knowledge-based content item to provide education regarding the new case law. In some instances, the processing server 102 could proactively create a new knowledge-based content item that is specifically tailored to the lawyer based on the preferences included in their user profile. In such cases, a user could be immediately provided with specially tailored content items to enhance their education any time a user knowledge gap occurs to keep them completely up to date in a specific industry or topic.

In embodiments, the processing server 102 provides incentives and/or rewards to users to complete the created knowledge-based content items. For example, the processing server 102 can implement a points-based reward system to increase user engagement and completion rates of the created knowledge-based content items. For example, each created knowledge-based content item can have a number of points that a user can earn for completing the created knowledge-based content item. The user can earn points based on completion of created knowledge-based content item or the user can earn points as the user progresses through a created knowledge-based content item. Further, the processing server 102 can award points based on user assessment scores, knowledge-based content created and/or submitted by a user, and learning milestones achieved by the user (e.g., a number of content items watched, a number of hours watched, etc.). The processing server 102 can store the points earned by the user in the user's user profile for redemption by the user. The user can redeem earned points for rewards such as, but not limited to, merchandise, additional created knowledge-based content items, employer rewards (e.g., time off, pay bonus, etc.), professional development opportunities, etc. For example, the processing server 102 can host an e-commerce store for merchandise provided by the entity in control of the processing server 102. In embodiments, a user's employer can create the rewards structure such that the rewards system is uniquely tailored to the employer's company and the user's position within the employer's company. For example, the employer can create a list of required created knowledge-based content items to be viewed by a user, e.g., an employee, and the employer can assign a number of points to be awarded to the user, e.g., the employee, based on the user's progress through the required created knowledge-based content items. The employer specific rewards structure can be stored in a user's profile or otherwise linked to the user's profile. For example, the rewards structure can be stored in a separate user profile such as a user profile associated with the user's employer and the user's user profile can be suitably linked to the employer's user profile.

The methods and systems discussed herein provide for the creation and management of knowledge-based content items using generative AI that provides for significantly more effective education for users while also greatly increasing the convenience at which users receive education. The use of machine learning and other techniques to ingest content items, generate knowledge maps, and identify user knowledge gaps in knowledge, focused learning objectives can be quickly and easily identified for a user with minimal interaction, enabling the user to receive content specific to their needs without requiring the searching necessary in traditional systems. Additionally, the use of generative AI in content creation as well as user feedback can ensure that the content is both up-to-date and presented in a manner that is most effective for the particular user that is consuming the content, drastically increasing its effectiveness over traditional methods of content delivery.

### Processing Server

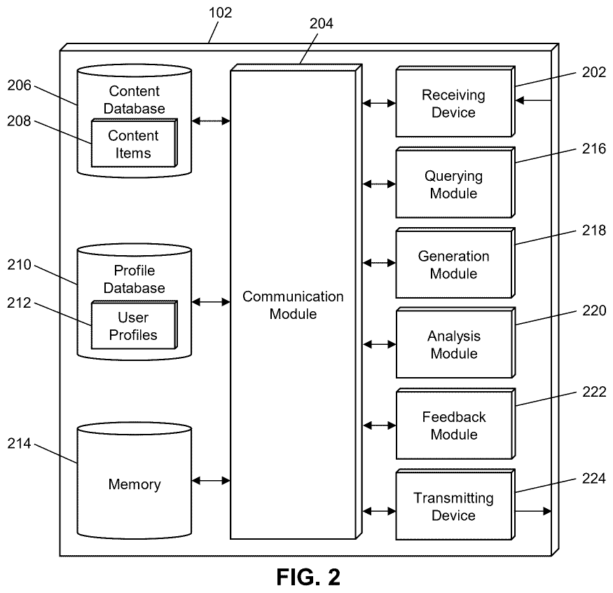

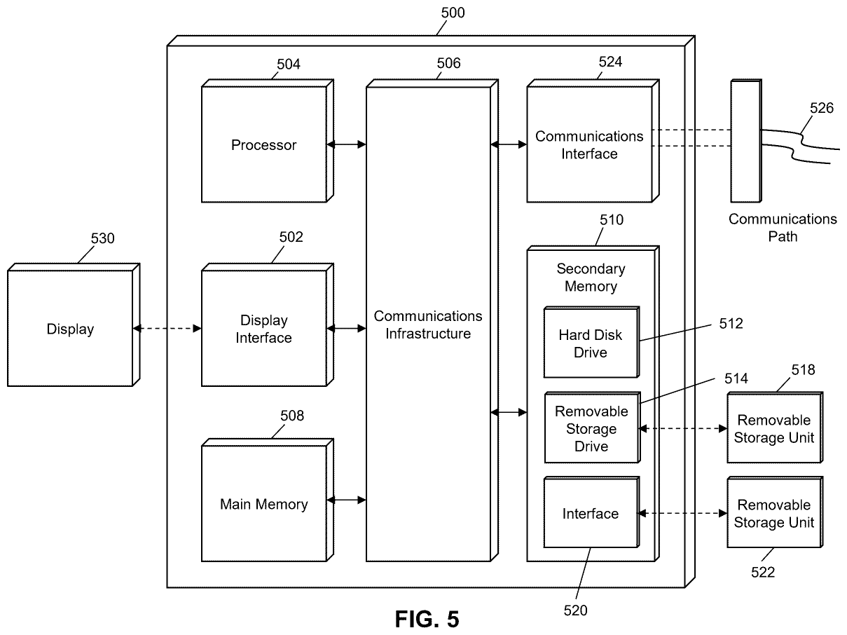

FIG. 2 illustrates an embodiment of a processing server 102. The processing server 102 can operate as any suitable component in the system 100 of FIG. 1, such as the processing server 102, the external data sources 104, and the computing device 108. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102.

The processing server 102 can include a receiving device 202. The receiving device 202 can be configured to receive data over one or more networks via one or more network protocols. In some instances, the receiving device 202 can be configured to receive data from external data sources 104, computing devices 108, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by external data sources 104 that can be superimposed or otherwise encoded with knowledge-based content items and other materials that can be classified, indexed, analyzed for metadata, and ingested by the processing server 102 and used in the generation of knowledge maps and creation of knowledge-based content items. The receiving device 202 can also be configured to receive data signals electronically transmitted by computing devices 108, which can be superimposed or otherwise encoded with user profiles, content requests, feedback data, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as the querying module 216, the generation module 218, the analysis module 220, and the feedback module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include a content database 206. The content database 206 can be configured to store a plurality of knowledge-based content items 208 using a suitable data storage format and schema. The content database 206 can be a relational database that utilizes structured query language for the storage, identification, modifying, updating, accessing, etc. of structured data sets stored therein. Each knowledge-based content item 208 can be stored along with any associated index data, metadata, classification data, etc. and can include knowledge-based content items 208 received from external data sources 104 and knowledge-based content items 208 created by the processing server 102.

The processing server 102 can also include a profile database 210. The profile database 210 can be configured to store one or more user profiles 212 using a suitable data storage format and schema. The profile database 210 can be a relational database that utilizes structured query language for the storage, identification, modifying, updating, accessing, etc. of structured data sets stored therein. Each user profile 212 can be a structured data set configured to store data related to a user, which can include user identification, user preferences, user knowledge-based history information, feedback data, computing device 108 communication data, current knowledge map user knowledge gaps, etc.

The processing server 102 can also include a memory 214. The memory 214 can be configured to store data for use by the processing server 102 in performing the functions discussed herein. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. For example, the memory 214 can be configured to store machine learning models, natural language processing data, algorithms and data for generative artificial intelligence (AI), etc.

The processing server 102 can include a querying module 216. The querying module 216 can be configured to execute queries on databases to identify information. The querying module 216 can receive one or more data values or query strings and can execute a query string based thereon on an indicated database, such as the content database 206 of the processing server 102 to identify information stored therein. The querying module 216 can then output the identified information to an appropriate engine or module of the processing server 102, as necessary. The querying module 216 can, for example, execute a query on the profile database 210 to identify a user profile 212 associated with a content request to identify user preferences included therein for use in creating specially tailored knowledge-based content items.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate knowledge maps, curriculum plans, knowledge-based content items, notification messages, user interfaces, feedback questionnaires, etc. The generation module 218 can also be configured to utilize a generative AI to create knowledge-based content items that are tailored to fill specific user knowledge gaps in education related to a particular knowledge map, which can be further tailored to a specific user, such as based on user preferences stored in a user profile 212 in the profile database 210. Further, the generation module can create transcripts for the knowledge-based content items for display with the knowledge-based content items. For example, if the knowledge-based content item is a video, the generation module 218 can create a transcript of the audio to enable content accessibility and ease of review.

The processing server 102 can also include an analysis module 220. The analysis module 220 can be configured to perform data analysis for the processing server 102 as part of the functions discussed herein. The analysis module 220 can receive instructions as input, can perform data analysis as instructed, and can output a result of the data analysis to one or more modules of the processing server 102. In some cases, the input can include the data to be analyzed and/or data to be used in the analysis. In other cases, the analysis module 220 can be configured to identify such data, such as in the content database 206 and/or memory 214. The analysis module 220 can be configured to, for example, analyze knowledge maps and user profiles to identify user knowledge gaps, analyze received knowledge-based content items for classification, indexing, and extracting metadata, etc.

The processing server 102 can also include a feedback module 222. The feedback module 222 can be configured to collect and process feedback for the processing server 102 as part of the functions discussed herein. The feedback module 222 can receive instructions as input, can collect or process feedback as instructed, and can output a result of the collection or processing to one or more modules of the processing server 102. In some cases, the input can include the feedback data to be processed and a request for feedback to be collected. The feedback module 222 can be configured to collect feedback from computing devices 108 regarding served knowledge-based content items 208 and process the feedback to update user preferences in user profiles 212, provide data to the generation module 218 to update a knowledge map, provide data to the generation module 218 for use in training the generative AI, etc.

The processing server 102 can also include a transmitting device 224. The transmitting device 224 can be configured to transmit data over one or more networks via one or more network protocols. In some instances, the transmitting device 224 can be configured to transmit data to external data sources 104, computing devices 108, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals to external data sources 104 that are superimposed or otherwise encoded with requests for knowledge-based content items and other materials, which can be delivered in parallel or sequentially, as discussed above. The transmitting device 224 can also be configured to electronically transmit data signals to computing devices 108, which can be superimposed or otherwise encoded with created knowledge-based content items 208, questionnaires, notification messages, user profile requests, etc.

### Process for Creation and Delivery of Knowledge-based Content

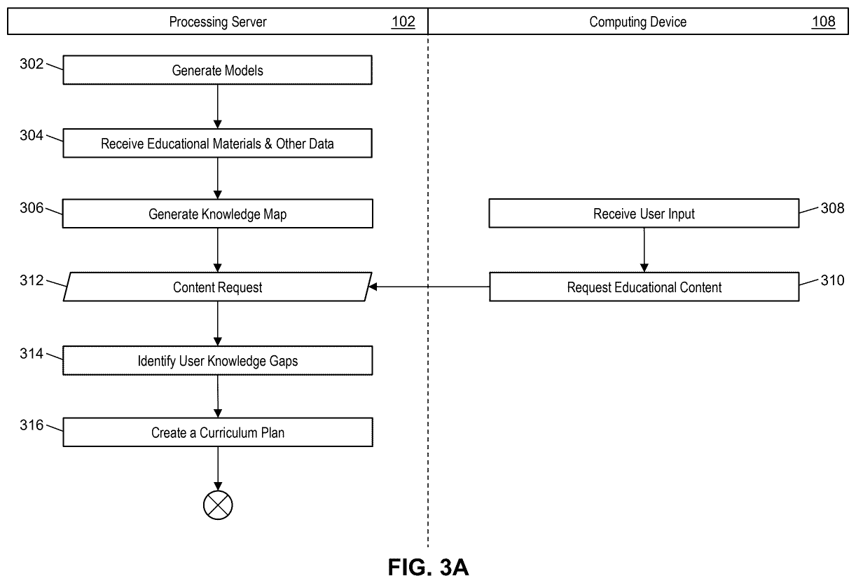

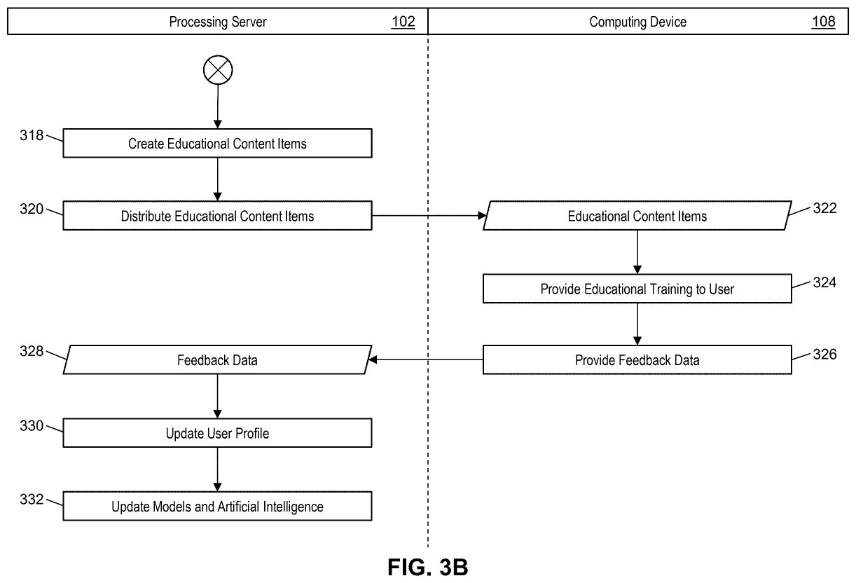

FIGS. 3A and 3B illustrate a process in the system 100 of FIG. 1 for the creation and delivery of specially tailored, up-to-date knowledge-based content to a computing device 108 by the processing server 102.

In step 302, the generation module 218 of the processing server 102 can generate machine learning models that are used in the generation of knowledge maps and identification of user knowledge gaps using data available to the processing server 102. In step 304, the receiving device 202 of the processing server 102 can receive a plurality of knowledge-based content items and other materials from a plurality of different external data sources 104 using the communication network 106 and any suitable communication method. As part of the receipt of the knowledge-based content items and other materials, the analysis module 220 of the processing server 102 can analyze and ingest the knowledge-based content items using RAG and CRAG, which can also include the extraction of metadata, indexing, and classification of the knowledge-based content items and other materials.

In step 306, the generation module 218 of the processing server 102 can generate a knowledge map for the specific topic or industry based on all the received and analyzed knowledge-based content items and other materials using the machine learning model.

In step 308, the computing device 108 can receive input from a user thereof, which can include a user identifier and a knowledge-based topic for which the user wishes to receive knowledge-based content for. In step 310, the computing device 108 can electronically transmit a request for knowledge-based content to the processing server 102 using the communication network 106 using any suitable communication method. In step 312, the receiving device 202 of the processing server 102 can receive the content request.

In step 314, the analysis module 220 of the processing server 102 can identify user knowledge gaps for the education topic included in the content request. Identifying user knowledge gaps can include the querying module 216 executing a query on the profile database 210 to identify a user profile 212 that includes the user identifier included in the content request. Further, identifying user knowledge gaps can include the querying module 216 executing a query on the content database 206 to identify knowledge maps corresponding to the knowledge-based topic included in the content request. The analysis module 220 of the processing server 102 can analyze the identified knowledge map and, the identified user profile 212 to identify the user's gaps in knowledge for the knowledge-based topic.

In step 316, the generation module 218 of the processing server 102 can generate a curriculum plan for the user. The curriculum plan can be based on a combination of the identified gaps in the user's knowledge as well as the desired learning goals provided by the user as included in the received content request.

In step 318, the generation module 218 of the processing server 102 can utilize a generative AI model to create a plurality of new knowledge-based content items that are tailored to satisfy the generated curriculum plan to fill the gaps in the user's knowledge with respect to the specific topic or industry. The new knowledge-based content items can be specifically tailored to the preferences of the user as indicated in the received content request and/or the identified user profile, such as in how the type and style of content that is created. In step 320, the transmitting device 224 of the processing server 102 can electronically transmit the plurality of new knowledge-based content items to the computing device 108 in response to the received content request.

In step 322, the computing device 108 can receive the specially tailored plurality of new knowledge-based content items from the processing server 102 via the communication network 106 using any suitable communication method. In step 324, the computing device 108 can present the specially tailored knowledge-based content items to the user thereof using a suitable interface, where the user can utilize the content items to expand their knowledge and fill their gaps in knowledge in the specific topic or industry. In step 326, the computing device 108 can capture feedback data from the user regarding the specially tailored knowledge-based content items, such as to capture user preferences in content type and style, effectiveness of knowledge conveyance, and increased knowledge or skills for specific concepts. The computing device 108 can electronically transmit the captured feedback data to the processing server 102 using the communication network 106 and suitable communication method.

In step 328, the receiving device 202 of the processing server 102 can receive the feedback data from the computing device 108. In step 330, the feedback module 222 of the processing server 102 can analyze the received feedback data to determine one or more new user preferences and/or modifications to the user preferences included in the received content request and provide the user preferences to the querying module 216 of the processing server 102 for the generation and execution of a query to update the identified user profile 212 in the profile database 210 of the processing server 102 for the user of the computing device 108 for use in tailoring future knowledge-based content items. In step 332, the feedback module 222 of the processing server 102 can also analyze the feedback data and provide relevant data to the generation module 218 of the processing server 102 to update and further train the machine learning models and generative artificial intelligence for improved knowledge mapping, gap analysis, and content creation.

### Exemplary Method for Creating and Managing Knowledge-based Content

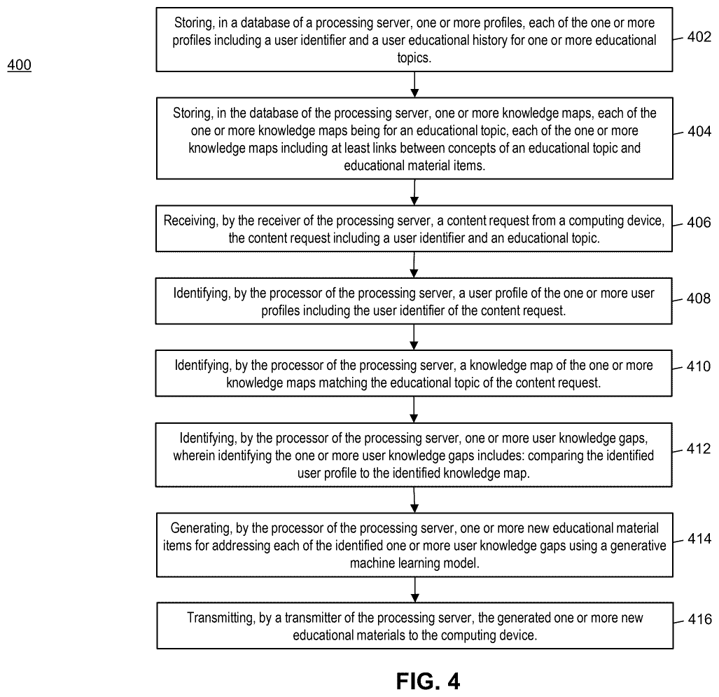

FIG. 4 illustrates a method 400 for the creation and management of knowledge-based content using generative artificial intelligence (AI).

In step 402, one or more profiles (e.g., user profiles 212) can be stored in a database (e.g., the profile database 210) of the processing server 102. Each of the one or more profiles (e.g., user profiles 212) can include at least a user identifier and a user knowledge-based history for one or more knowledge-based topics. The user knowledge-based history for the one or more knowledge-based topics can include one or more of: a user assessment, a user pre-test result, past knowledge-based materials viewed, past knowledge-based courses attended, and a user web browser history.

In step 404, one or more knowledge maps can be stored in a database (e.g., the content database 206) of the processing server (e.g., processing server 102). Each of the one or more knowledge maps can be for a knowledge-based topic and each of the one or more knowledge maps can include at least links between concepts of a knowledge-based topic and knowledge-based material items. The one or more knowledge maps can be generated by receiving a plurality of knowledge-based material items associated with a knowledge-based topic by a receiver (e.g., receiving device 202) of a processing server (e.g., processing server 102). A processor (e.g., the analysis module 220) of a processing server (e.g., the processing server 102) can extract key metadata from each of the knowledge-based material items of the plurality of knowledge-based material items and analyze the key metadata from each of the knowledge-based material items of the plurality of knowledge-based material items using one or more machine learning algorithms to link the plurality of knowledge-based material items to concepts of an knowledge-based topic. A processor (e.g., the generation module 218) of the processing server (e.g., the processing server 102) can generate the one or more knowledge maps based on the analysis of the received plurality of knowledge-based material items.

In step 406, a content request can be received by a receiver (e.g., receiving device 202) of a processing server (e.g., processing server 102) from a computing device (e.g., computing device 108). The content request includes at least a user identifier and a knowledge-based topic.

In step 408, a processor (e.g., the querying module 216) of the processing server (e.g., the processing server 102) can identify a user profile of the one or more user profiles (e.g., the user profiles 212) including the user identifier of the content request. In step 410, a processor (e.g., the querying module 216) of the processing server (e.g., the processing server 102) can identify a knowledge map of the one or more knowledge maps matching the knowledge-based topic of the content request.

In step 412, a processor (e.g., the analysis module 220) of the processing server (e.g., the processing server 102) can identify one or more user knowledge gaps. For example, a processor (e.g., the analysis module 220) of the processing server (e.g., the processing server 102) can compare the identified user profile to the identified knowledge map to identify the one or more user knowledge gaps. The processor (e.g., the analysis module 220) of the processing server (e.g., the processing server 102) can identify the one or more user knowledge gaps are identified using at least one of: natural language processing and a machine learning model.

In step 414, one or more new knowledge-based material items can be generated by a processor (e.g., the generation module 218) of the processing server (e.g., the processing server 102) for addressing each of the identified one or more user knowledge gaps using a generative machine learning model. Generating the one or more new knowledge-based material items can include generating by a processor (e.g., the generation module 218) of the processing server (e.g., the processing server 102) a machine learning model input based on the identified one or more user knowledge gaps, the machine learning model input requesting the one or more new knowledge-based materials. In embodiments, generating the one or more new knowledge-based material items in the method 400 can further include receiving by a receiver (e.g., receiving device 202) of a processing server (e.g., the processing server 102) one or more additional knowledge-based material items associated with the knowledge-based topic and generating by a processor (e.g., the generation module 218) of the processing server (e.g., the processing server 102) an augmented machine learning model input based on the received one or more additional knowledge-based materials and the identified one or more user knowledge gaps, the augmented machine learning model input requesting the one or more new knowledge-based materials.

In some embodiments, the method 400 can also include indexing, by the processor (e.g., analysis module 220) of the processing server, the generated one or more new knowledge-based materials according to a taxonomy of the generated knowledge map prior to transmitting the generated one or more new knowledge-based materials. In one embodiment, the method 400 can further include compiling, by the processor (e.g., generation module 218) of the processing server, the generated one or more new knowledge-based materials into a plurality of briefings, wherein the generated one or more new knowledge-based materials can be transmitted in the compiled plurality of briefings.

In step 416, the generated one or more new knowledge-based materials can be transmitted by a transmitter (e.g., the transmitting device 224) of a processing server (e.g., the processing server 102) to the computing device (e.g., the computing device 108). In some embodiments, the one or more knowledge-based materials can include at least one of: text, video, podcast, and interactive media formats. In one embodiment, the method 400 can also include receiving, by the receiver of the processing server, feedback data associated with the generated one or more knowledge-based materials. In a further embodiment, the method 400 can even further include: updating, by the processor (e.g., feedback module 222) of the processing server, the knowledge map based on the received feedback data; identifying, by the processor (e.g., analysis module 220) of the processing server, at least one gap in the updated knowledge map; updating, by the processor (e.g., generation module 218) of the processing server, the curriculum plan based on the identified at least one gap; generating, by the processor (e.g., generation module 218) of the processing server, one or more updated knowledge-based material items for addressing each of the identified at least one gap using generative AI; and transmitting, by the transmitter of the processing server, the generated one or more updated knowledge-based materials.

### Computer System Architecture

FIG. 5 illustrates a computer system 500 in which embodiments of the present disclosure, or portions thereof, can be implemented as computer-readable code. For example, the processing server 102, external data sources 104, and computing device 108 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores. ” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems, and methods for creating and managing knowledge-based content using generative AI. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for creating and managing knowledge-based content using generative artificial intelligence (AI), comprising:
storing, in a database of a processing server, one or more profiles, each of the one or more profiles including a user identifier and a user knowledge-based history for one or more knowledge-based topics;
storing, in the database of the processing server, one or more knowledge maps, each of the one or more knowledge maps being for a knowledge-based topic, each of the one or more knowledge maps including at least links between concepts of a knowledge-based topic and knowledge-based material items;
receiving, by the receiver of the processing server, a content request from a computing device, the content request including a user identifier and a knowledge-based topic;
identifying, by a processor of the processing server, a user profile of the one or more user profiles including the user identifier of the content request;
identifying, by the processor of the processing server, a knowledge map of the one or more knowledge maps matching the knowledge-based topic of the content request;
identifying, by the processor of the processing server, one or more user knowledge gaps, wherein identifying the one or more user knowledge gaps includes:
comparing the identified user profile to the identified knowledge map;
generating, by the processor of the processing server, one or more new knowledge-based material items for addressing each of the identified one or more user knowledge gaps using a generative machine learning model; and
transmitting, by a transmitter of the processing server, the generated one or more new knowledge-based materials to the computing device.

2. The method of claim 1, wherein each of the one or more knowledge maps stored in the database are generated using the method comprising:
receiving, by the receiver of the processing server, a plurality of knowledge-based material items associated with a knowledge-based topic;
extracting, by the processor of the processing server, key metadata from each of the knowledge-based material items of the plurality of knowledge-based material items;
analyzing, by the processor of the processing server, the key metadata from each of the knowledge-based material items of the plurality of knowledge-based material items using one or more machine learning algorithms to link the plurality of knowledge-based material items to concepts of a knowledge-based topic; and
generating, by a processor of the processing server, the one or more knowledge maps based on the analysis of the received plurality of knowledge-based material items.

3. The method of claim 1, wherein the generating the one or more new knowledge-based material items further comprises:
generating, by the processor of the processing server, a machine learning model input based on the identified one or more user knowledge gaps, the machine learning model input requesting the one or more new knowledge-based materials.

4. The method of claim 1, wherein the generating the one or more new knowledge-based material items further comprises:
receiving, by the receiver of the processing server, one or more additional knowledge-based material items associated with the knowledge-based topic; and
generating, by the processor of the processing server, an augmented machine learning model input based on the received one or more additional knowledge-based materials and the identified one or more user knowledge gaps, the augmented machine learning model input requesting the one or more new knowledge-based materials.

5. The method of claim 1, wherein the one or more user knowledge gaps are identified using at least one of: natural language processing and a machine learning model.

6. The method of claim 1, further comprising:
indexing, by the processor of the processing server, the generated one or more new knowledge-based materials according to a taxonomy of the identified knowledge map prior to transmitting the generated one or more new knowledge-based materials to the computing device.

7. The method of claim 1, further comprising:
compiling, by the processor of the processing server, the generated one or more new knowledge-based materials into a plurality of briefings, wherein the generated one or more new knowledge-based materials are transmitted to the computing device in the compiled plurality of briefings.

8. The method of claim 1, wherein the one or more knowledge-based materials includes at least one of: text, video, podcast, and interactive media formats.

9. The method of claim 1, further comprising:
receiving, by the receiver of the processing server, feedback data associated with the generated one or more new knowledge-based materials; and
updating, by the processor of the processing server, the identified knowledge map based on the received feedback data.

10. The method of claim 1, wherein the user knowledge-based history for one or more knowledge-based topics includes one or more of: a user assessment, a user pre-test result, past knowledge-based materials viewed, past knowledge-based courses attended, and a user web browser history.

11. A system for creating and managing knowledge-based content using generative artificial intelligence (AI), comprising:
a processor; and
a non-transitory memory coupled to the processor and storing instructions that, when executed by the processor, cause the system to perform operations, comprising:
storing, in a database, one or more profiles, each of the one or more profiles including a user identifier and a user knowledge-based history for one or more knowledge-based topics;
storing, in the database, one or more knowledge maps, each of the one or more knowledge maps being for a knowledge-based topic, each of the one or more knowledge maps including at least links between concepts of a knowledge-based topic and knowledge-based material items;
receiving a content request from a computing device, the content request including a user identifier and a knowledge-based topic;
identifying a user profile of the one or more user profiles including the user identifier of the content request;
identifying a knowledge map of the one or more knowledge maps matching the knowledge-based topic of the content request;
identifying one or more user knowledge gaps, wherein identifying the one or more user knowledge gaps includes:
comparing the identified user profile to the identified knowledge map;
generating one or more new knowledge-based material items for addressing each of the identified one or more user knowledge gaps using a generative machine learning model; and
transmitting the generated one or more new knowledge-based materials to the computing device.

12. The system of claim 11, wherein each of the one or more knowledge maps stored in the database are generated using a method that when executed by the processor, cause the system to perform operations comprising:
receiving a plurality of knowledge-based material items associated with a knowledge-based topic;
extracting key metadata from each of the knowledge-based material items of the plurality of knowledge-based material items;
analyzing the key metadata from each of the knowledge-based material items of the plurality of knowledge-based material items using one or more machine learning algorithms to link the plurality of knowledge-based material items to concepts of a knowledge-based topic; and
generating the one or more knowledge maps based on the analysis of the received plurality of knowledge-based material items.

13. The system of claim 11, wherein the generating the one or more new knowledge-based material items further comprises instructions that, when executed by the processor, cause the system to perform operations, comprising:
generating a machine learning model input based on the identified one or more user knowledge gaps, the machine learning model input requesting the one or more new knowledge-based materials.

14. The system of claim 11, wherein the generating the one or more new knowledge-based material items further comprises instructions that, when executed by the processor, cause the system to perform operations, comprising:
receiving one or more additional knowledge-based material items associated with the knowledge-based topic; and
generating an augmented machine learning model input based on the received one or more additional knowledge-based materials and the identified one or more user knowledge gaps, the augmented machine learning model input requesting the one or more new knowledge-based materials.

15. The system of claim 11, wherein the one or more user knowledge gaps are identified using at least one of: natural language processing and a machine learning model.

16. The system of claim 11, the operations further comprising:
indexing the generated one or more new knowledge-based materials according to a taxonomy of the identified knowledge map prior to transmitting the generated one or more new knowledge-based materials to the computing device.

17. The system of claim 11, the operations further comprising:
compiling the generated one or more new knowledge-based materials into a plurality of briefings, wherein the generated one or more new knowledge-based materials are transmitted to the computing device in the compiled plurality of briefings.

18. The system of claim 11, wherein the one or more knowledge-based materials includes at least one of: text, video, podcast, and interactive media formats.

19. The system of claim 11, the operations further comprising:
receiving feedback data associated with the generated one or more new knowledge-based materials; and
updating the identified knowledge map based on the received feedback data.

20. The system of claim 19, wherein the user knowledge-based history for one or more knowledge-based topics includes one or more of: a user assessment, a user pre-test result, past knowledge-based materials viewed, past knowledge-based courses attended, and a user web browser history.
